(19) United States
(12) Patent Application Publication
(10) Pub. No.: US 2007/0217858 A1
(43) Pub. Date: Sep. 20, 2007

(54) Lead Cartridge and Writing Tool into which Lead Cartridge is to be Incorporated

(75) Inventors: Hidehei Kageyama, Saitama (JP); Yoshio Noguchi, Saitama (JP)

Correspondence Address: MILLER, MATTHIAS & HULL, ONE NORTH FRANKLIN STREET, SUITE 2350, CHICAGO, IL, 60606, US

(73) Assignee: Kotobuki & Co, Ltd., Saitama (JP)

(21) Appl. No.: 11/674,829

(22) Filed: Feb. 14, 2007

(30) Foreign Application Priority Data
Mar. 20, 2006 (JP) 2006-77084
Feb. 9, 2007 (JP) 2007-30886

(51) Int. Cl. B43K 21/22; B43K 23/00

(52) U.S. Cl. 401/92; 401/89

(57) ABSTRACT

A lead cartridge capable of holding a rod-shaped object of a sufficient length and allowing simultaneous replacement of the lead and the rod-shaped object is to be provided. A lead cartridge which includes a lead tank for containing leads and is detachably incorporated into a mechanical pencil to supply leads has a rod-shaped object feeding mechanism which propels the rod-shaped object by turning manipulation. This rod-shaped object feeding mechanism is configured of a spiral groove formed in the inner circumferential surface of a case comprising the lead tank, a guide sleeve which is arranged in the case to be unable to move in the axial direction and able to turn relative to the case and in which guide holes extending in the axial direction are formed, and a receptacle which is slidably fitted into the guide holes of the guide sleeve and has a male thread screwing into the spiral groove. A rod-shaped object is held by the receptacle. When the lead cartridge is incorporated into a mechanical pencil, the case becomes unable to turn relative to the outer sleeve of the mechanical pencil, and part of the guide sleeve protrudes out of the mechanical pencil.

### BACKGROUND OF THE INVENTION

1. Field of the Invention

The present invention relates to a lead cartridge for replenishing a writing tool with leads or replacing leads in a writing tool and to a writing tool into which the lead cartridge is to be incorporated.

2. Description of the Related Art

When replenishing a writing tool with leads, a user for the writing tool usually removes an eraser from an eraser receptacle engaged with the rear part of a lead tank disposed within the body of the writing tool, extracts leads from a lead case which is a separate product from the writing tool and contains spare leads, and insert the leads into the lead tank through the eraser receptacle.

As alternative way of replenishing a writing tool with leads, it is also known that a lead cartridge containing leads is replaced, and such a lead cartridges is described in Japanese Utility Model Publication Laid-Open No. 64-17784. According to the publication, an open pipe is fixed to a leading guide of a writing tool, an opening/closing mechanism having an elastic opening/closing part is disposed at the tip of the lead cartridge, and the elastic opening/closing part is opened when it is in its position of engagement with the leading guide by the open pipe or is closed when it is in a position of non-engagement with the leading guide.

### SUMMARY OF THE INVENTION

Although the lead cartridge according to the publication or any other lead cartridge now commercially distributed may be equipped at its rear end with a rod-shaped eraser, the equipped eraser is usually small and has to be replaced earlier than the lead cartridge is. As a result, it is necessary to replace or replenish the leads and the eraser respectively.

An object of the present invention, attempted in view of this problem, is to provide a lead cartridge which is capable of holding a rod-shaped object of a sufficient length and allowing the replacement of leads and the rod-shaped object at the same time and a writing tool in to which the lead cartridge is to be incorporated.

In order to achieve the object stated above, a lead cartridge according to the invention including a tank for containing leads and adapted to be detachably incorporated into a writing tool to supply leads, further comprises a rod-shaped object feeding mechanism for propelling a rod-shaped object by a turning manipulation.

According to the invention, equipping the lead cartridge with a rod-shaped object feeding mechanism for propelling a rod-shaped object enables the rod-shaped object to have a sufficient length in the axial direction and thereby to extend the exhaustion of the rod-shaped object until the replacement timing for the lead cartridge and accordingly to dispense with separate replacement of the lead and of the rod-shaped object.

The rod-shaped object feeding mechanism can comprises a spiral groove formed in the inner circumferential surface of a case comprising the tank, a guide sleeve which is disposed within the case so as to be unmovable in the axial direction and rotatable relative to the case and is formed with a guide hole extending in the axial direction, and a receptacle for holding a rod-shaped object, which is slidably fitted into the guide hole of the guide sleeve and has a male thread screwing into the spiral groove. When the lead cartridge is incorporated into the writing tool, the case is unrotatable relative to an outer sleeve of the writing tool and part of the guide sleeve protrudes from the writing tool to be subjected to the turning manipulation. By forming of the spiral groove for propelling the rod-shaped object on the inner circumferential surface of the case constituting the tank enables the rod-shaped object feeding mechanism to be integrally incorporated into the lead cartridge. When the lead cartridge is incorporated into a writing tool, the rod-shaped object can be propelled from the writing tool by turning the guide sleeve partly protruding from the writing tool.

Alternatively, the rod-shaped object feeding mechanism can comprise a guide sleeve which is coupled to a case constituting the tank so as to be unmovable in the axial direction and unrotatable relative to the case and is formed with a guide hole extending in the axial direction, a spiral sleeve which is arranged outside of the guide sleeve so as to be unmovable in the axial direction and rotatable relative to the guide sleeve and is formed in an inner circumferential surface with a spiral groove, and a receptacle for holding a rod-shaped object, which is slidably fitted into the guide hole of the guide sleeve and has a male thread screwing into the spiral groove. When the lead cartridge is incorporated into the writing tool, the case is unrotatable relative to an outer sleeve of the writing tool, and part of the spiral sleeve protrudes from the writing tool to be subjected to the turning manipulation. By coupling of the guide sleeve to the case constituting the tank enables the rod-shaped object feeding mechanism to be integrally incorporated into the lead cartridge. When the lead cartridge is incorporated into a writing tool, the rod-shaped object can be propelled from the writing tool by turning the spiral sleeve partly protruding from the writing tool. By decoupling the case and the guide sleeve, the rod-shaped object feeding mechanism is enabled to be used as an independent unit as well.

Alternatively, the rod-shaped object feeding mechanism can comprise a spiral sleeve which is coupled to a case constituting the tank so as to be unmovable in the axial direction and unrotatable relative to the case and is formed in an inner circumferential surface with a spiral groove, a guide sleeve which is arranged inside of the guide sleeve so as to be unmovable in the axial direction and rotatable relative to the spiral sleeve and is formed with a guide hole extending in the axial direction, and a receptacle for holding a rod-shaped object, which is slidably fitted into the guide hole of the guide sleeve and has a male thread screwing into the spiral groove. When the lead cartridge is incorporated into the writing tool, the case is unrotatable relative to an outer sleeve of the writing tool, and part of the guide sleeve protrudes from the writing tool to be subjected to the turning manipulation. By coupling of the spiral sleeve to the case constituting the tank enables the rod-shaped object feeding mechanism to be integrally incorporated into the lead cartridge. When the lead cartridge is incorporated into a writing tool, the rod-shaped object can be propelled from the writing tool by turning the guide sleeve partly protruding from the writing tool. By decoupling the case and the spiral sleeve, the rod-shaped object feeding mechanism is enabled to be used as an independent unit as well,

The guide sleeve can engage with an engaging portion formed on the circumferential surface of the case comprising the tank to be held so as to be unmovable in the axial direction within the case. Alternatively, the spiral sleeve can engage with an engaging portion formed on the circumferential surface of the case comprising the tank to be held so as to be unmovable in the axial direction within the case. When the rod-shaped object feeding mechanism is to be assembled to the case, it can be easily accomplished by engaging the engaging portion. When the rod-shaped object feeding mechanism is desired to be removed from the case, it can be easily taken out of the case by disengaging the engaging portion.

Preferably, a display part on which lead information regarding leads contained in the tank is displayed can be provided on the outer circumferential part of the lead cartridge. The display part can provide information on the contained leads and the lead cartridge can be appropriately incorporated into the writing tool.

Preferably, at least part of the case comprising the tank is composed of a transparent material which makes visible an inside of the tank. As the inside of the tank is made visible, it is possible to check from outside the state of accommodation of leads in the tank or the other status.

Preferably, in a writing tool into which the lead cartridge is to be incorporated, the lead cartridge is made visible through at least part of an outer sleeve of the writing tool. It is possible to check from outside of the writing tool, lead information and the state of accommodation of leads in the tank by visually inspecting the lead cartridge through the outer sleeve of the writing tool in a state in which the lead cartridge is incorporated into the writing tool

At least part of the outer sleeve of the writing tool is composed of a transparent material and the part composed of the transparent material functions as a lens. It is possible to check from outside of the writing tool, lead information and the state of accommodation in the tank in an enlarged view by utilizing the lens function of part of the outer sleeve

The present disclosure relates to subject manner contained in Japanese Patent Application Nos. 2006-77084 filed on Mar. 20, 2006, and 2007-030886 filed on Feb. 9, 2007, which is expressly incorporated herein by reference in its entirety.

### BRIEF DESCRIPTION OF THE DRAWINGS

FIG. 1 shows an overall view of a lead cartridge, which is a preferred embodiment of the present invention;

FIG. 2 is a longitudinal sectional view of the lead cartridge shown in FIG. 1;

FIG. 3 is a longitudinal sectional view of a case;

FIG. 4A is a plan view, and FIG. 4B a sectional view, of a guide sleeve;

FIG. 5 is a plan view, FIG. 5B a front view and FIG. 5C a sectional view, of an eraser receptacle;

FIG. 6 is a sectional view showing a state in which the lead cartridge shown in FIG. 1 is incorporated into a mechanical pencil;

FIG. 7 is a longitudinal section of the body of an outer sleeve;

FIG. 8 is a longitudinal sectional view of a chuck joint;

FIG. 9 is a sectional view of a variation of the chuck joint;

FIGS. 10A and 10B are sectional views showing the procedure of linking the lead cartridge with the chuck joint;

FIG. 11 shows another side view of a mechanical pencil into which the lead cartridge is incorporated;

FIG. 12 is a longitudinal sectional view of a lead cartridge, according to another preferred embodiment of the invention;

FIG. 13 shows an exploded view of the lead cartridge shown in FIG. 12;

FIG. 14 is an exploded longitudinal sectional view of the lead cartridge shown in FIG. 12

FIG. 15 is a sectional view showing a state in which the lead cartridge shown in FIG. 12 is incorporated into a mechanical pencil; and

FIG. 16 is a longitudinal sectional view of a lead cartridge, according to still another preferred embodiment of the invention;

FIG. 17 shows an exploded view of the lead cartridge shown in FIG. 16; and

FIG. 18 is a sectional view showing a state in which the lead cartridge shown in FIG. 16 is incorporated into a mechanical pencil.

### DETAILED DESCRIPTION OF THE PREFERRED EMBODIMENTS

Preferred embodiments of the present invention will be described below with reference to the accompanying drawings.

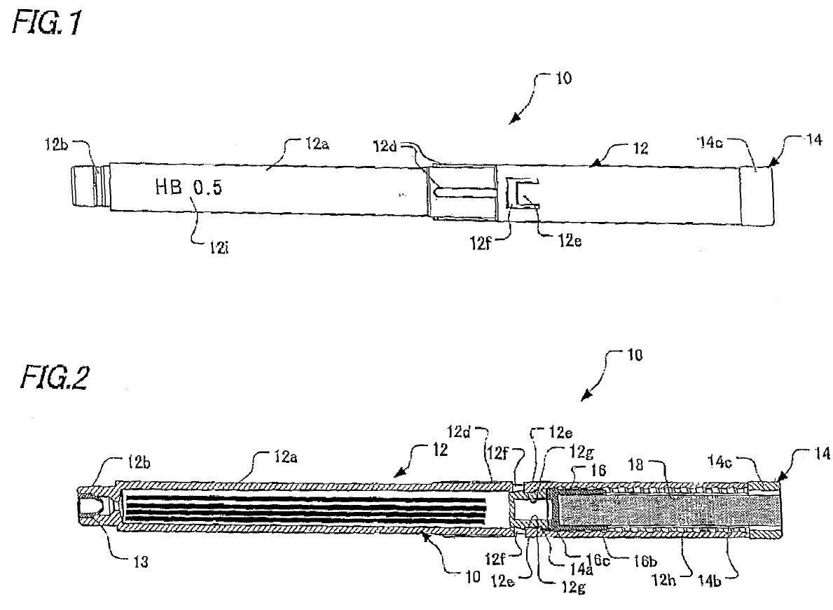

FIG. 1 shows an overall view of a lead cartridge according to a preferred embodiment of the invention, and FIG. 2 shows a longitudinal sectional view of this lead cartridge.

Referring to the drawings, a lead cartridge 10 comprises a case 12, a packing 13, a guide sleeve 14, and an eraser receptacle 16 to hold an eraser 18 which is a rod-shaped object.

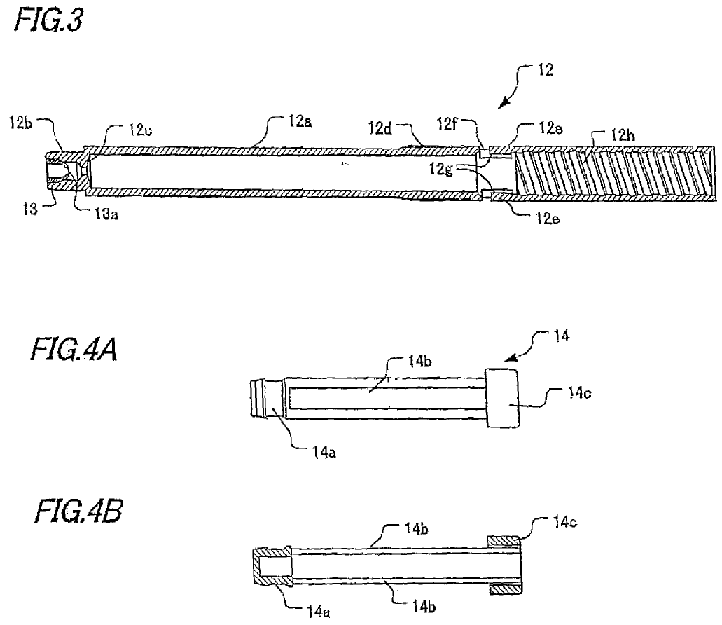

The case 12 is a hollow cylinder as shown in FIG. 3, comprising a lead tank 12a in its central portion to contain a plurality of leads for replenishment or replacement. The case 12 is provided on the front side of the lead tank 12a with a detachable coupling 12b having a reduced diameter than that of the portion defining lead tank 12a. A contracted part 12c, reduced in bore, is formed on the boundary between the lead tank 12a and the detachable coupling 12b. The packing 13, composed of an elastic material, is so inserted into the detachable coupling 12b from its tip as to protrude toward the contracted part 12c. The central aperture 13a of the packing 13 is smaller in its natural state than the diameter of a lead, and in this state no lead in the lead tank 12a can pass the central aperture 13a and is prevented from escaping from the detachable coupling 12b.

A plurality of ribs 12d for preventing rotation are provided on the outer circumference of the case 12. The case 12 is also provided on the circumferential surface on the rear side of the lead tank 12a with a pair of engaging pieces 12e as engaging portions. The engaging pieces 12e axe surrounded by a U-shaped slit 12f formed in the circumferential surface of the case 12, and are thereby enabled to be elastically displaced in the radial direction. Engaging stubs 12g are formed on the inner circumferential surface of the engaging pieces 12e. Further, a spiral groove 12h is formed in the inner circumferential surface positioned to rearward of the engaging pieces 12e of the case 12.

Preferably, a display part 12i on which some items of lead information such as the diameter, hardness and color of leads contained therein are printed, is provided on the outer surface of the case 12. This would facilitate appropriate choice of a lead cartridge 10 by the user.

The guide sleeve 14 is arranged within the case 12 so as to correspond to the engaging pieces 12e and the spiral groove 12h of the case 12 described above. As shown in FIG. 4, an annular groove 14a as an engaging portion is formed in the outer circumferential surface of the front end of the guide sleeve 14, and the engaging stubs 12g of the engaging pieces 12e engage with the inside of this annular groove 14a. This engagement enables the guide sleeve 14 to rotate relative to the case 12 but it is unable to move in the axial direction relative to the case 12. A pair of guide holes 14b extending in the axial direction are formed in the central portion of the guide sleeve 14, and a manipulating part 14c expanded in diameter is formed at the rear end of the guide sleeve 14, The manipulating part 14c, arranged outside the case 12, is in contact with the rear end surface of the case 12.

In assembling the guide sleeve 14 into the case 12, as the engaging pieces 12e permit elastic displacement, when the guide sleeve 14 is inserted into the case 12, the guide sleeve 14 is enabled to be easily engaged with the case 12 by the deformation of the engaging pieces 12e. In addition, when it is desired to remove the guide sleeve 14 from the case 12 after assembly, the guide sleeve 14 can be easily taken out of the case 12 by deforming the engaging pieces 12e from outside outward in the radial direction by using a jig or the like. Therefore, even if a wrong kind or the wrong number of leads are loaded at the time of assembly and that error is revealed after the guide sleeve 14 is assembled into the case 12, the error can be corrected by removing the guide sleeve 14 from the case 12. It has to be noted that, instead of engaging the engaging pieces 12e as engaging portions with the annular groove 14a of the guide sleeve 14 as engaging portion, annular concave rib and convex rib formed as engaging portions between the inner circumferential surface of the case 12 and the outer circumferential surface of the guide sleeve 14 can as well be engaged, and fitting these concave and convex ribs together enables the guide sleeve 14 to be turnably engaged with the case 12.

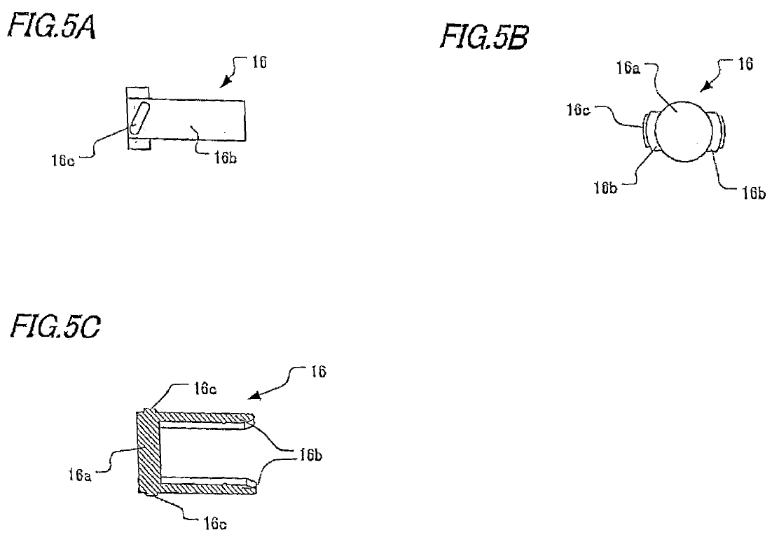

The eraser receptacle 16 is arranged within the guide sleeve 14 to be slidable in the axial direction relative to the guide sleeve 14 and to be turnable relative to the case 12. As shown in FIG. 5, the eraser receptacle 16 has a bottom part 16a receiving the bottom surface of the eraser 18 and a pair of pinching pieces 16b extending backward from the bottom part 16a to pinch the eraser 18 between them. The pinching pieces 16b, fitted into the guide holes 14b of the guide sleeve 14, can slide in the guide holes 14b in the axial direction. Further, a male thread 16c is formed on the outer circumferential surface of the pinching pieces 16b, and screws into the spiral groove 12h of the case 12.

The spiral groove 12h of the case 12, the guide sleeve 14 and the eraser receptacle 16 constitute a rod-shaped object feeding mechanism which is to be integrated with the lead cartridge 10.

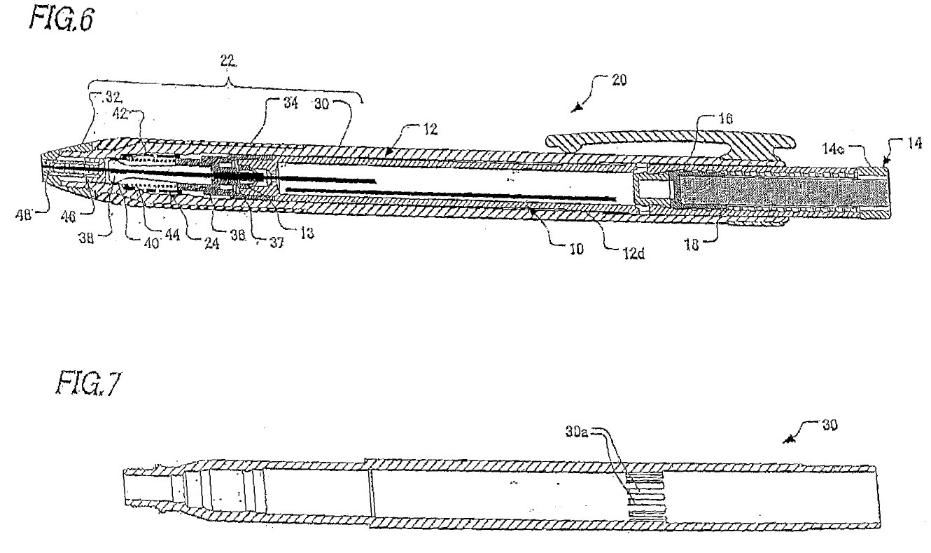

FIG. 6 shows a state in which the lead cartridge 10 configured as described above is incorporated into a mechanical pencil 20, which is a writing tool. This mechanical pencil 20 has an outer sleeve 22 and a lead feeding mechanism 24 built into the outer sleeve 22.

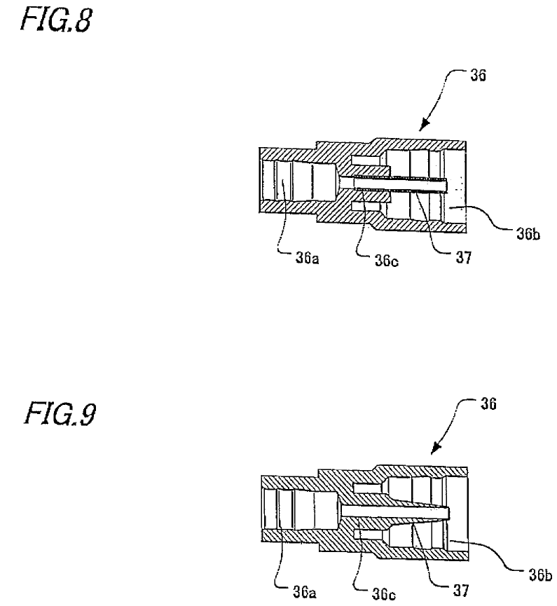

The outer sleeve 22 comprises a body 30, a tip element 32 screwed on the tip of the body 30 and a grip element 34 fitted to the grip portion of the body 30. As shown in FIG. 7, grooves 30a for preventing rotation are formed in the inner circumferential surface of the body 30. Engagement of the ribs 12d of the case 12 of the lead cartridge 10 with these grooves 30a prevents the case 12 and the outer sleeve 22 from relatively turning.

The lead feeding mechanism 24 has a chuck joint 36, a lead chuck 38 which, with its rear end pressed into the chuck joint 36, fastens and feeds out a lead, a chuck ring 40 which, fitted on the outer circumferential side of the chuck portion of the lead chuck 38, can fasten the chuck portion of the lead chuck 38, a sleeve 42 which restricts the backward movement of the chuck ring 40, a chuck spring 44 which, positioned between the sleeve 42 and the chuck joint 36 urges the chuck joint 36 and the lead chuck 38 backward, a slider 46 which is movably disposed within the tip element 32, and a lead pipe 48.

The chuck joint 36, as shown in FIG. 8 on an enlarged scale, has a chuck fitting hole 36a into which the rear end of the lead chuck 38 is pressed, a cartridge fitting hole 36b to which the detachable coupling 12b of the case 12 of the lead cartridge 10 is detachably coupled, and a lead feeding hole 36c communicating the chuck fitting hole 36a and the cartridge fitting hole 36b for guiding lead to penetrate one by one. A guide pipe 37 is fixedly inserted into the lead feeding hole 36c. Alternatively, this guide pipe 37 may be molded integrally with the chuck joint 36 as shown in FIG. 9.

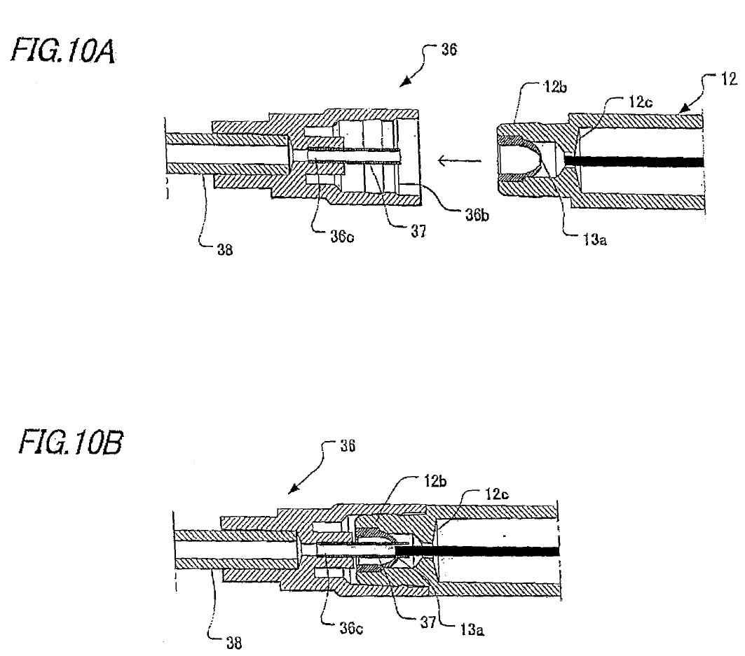

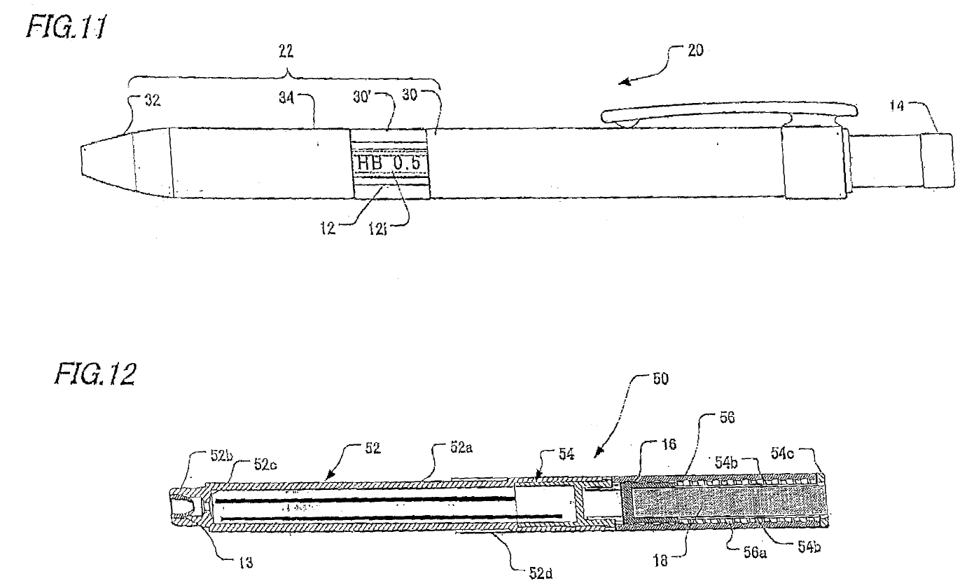

The coupling of the lead cartridge 10 and the chuck joint 36 is accomplished by inserting the detachable coupling 12b of the case 12 of the lead cartridge 10 into the cartridge fitting hole 36b as shown in FIG. 10. This causes the ridged surface of the outer circumferential surface of the detachable coupling 12b and the ridged surface of the inner circumferential surface of the cartridge fitting hole 36b to mesh with each other to cause the case 12 and the chuck joint 36 to be coupled to each other. At the same time, the guide pipe 37 is forcedly inserted into the central aperture 13a of the packing 13 to enlarge the central aperture 13a to enable a lead in the lead tank 12a to pass the central aperture 13a and the lead feeding hole 36c. In this way, a lead in the lead tank 12a is fed to the lead chuck 38. When the lead cartridge 10 is to be taken off, it can be easily accomplished by drawing the case 12 out of the outer sleeve 22.

When the lead cartridge 10 is incorporated into the mechanical pencil 20 as described above, the rear end portion of the lead cartridge 10 including the manipulating part 14c of the guide sleeve 14 protrudes from the rear end of the outer sleeve 22. When the rear end portion of this lead cartridge 10 is knocked, the chuck joint 36, the lead chuck 38 and the chuck ring 40 move ahead together with the lead cartridge 10, resulting in lead feeding as is well known to make the lead available for use in writing.

Further, when the eraser is to be used, the manipulating part 14c in the rear end portion is turned in a state in which the outer sleeve 22 is fixed. Since the outer sleeve 22 and the case 12 are prevented from relatively turning, the eraser receptacle 16 which turns integrally with the guide sleeve 14 turns relative to the case 12. Then, as the male thread 16c of the eraser receptacle 16 moves along the spiral groove 12h, the eraser 18 is let out. When the manipulating part 14c is turned in the other direction, the eraser 18 is retreated into the case 12,

Since the eraser 18 can be propelled in this way, a sufficient length in the axial direction can be secured for the eraser 18 until the lead cartridge 10 is up for replacement, making it unnecessary for the leads and the eraser to be replaced on separate occasions,

Further it is possible to provide a transparent shaft 30′ in part of the body 30 of the outer sleeve 22 as shown in FIG. 11. If the position of this transparent shaft 30′ is matched with that of the display part 12i of the case 12 of the lead cartridge 10 in the axial direction within the body 30, information on the lead and other items can be conveniently seen from outside even after the lead cartridge 10 is incorporated. By appropriately varying the wall thickness of the transparent shaft 30′ and shaping the inner sectional profile of the transparent shaft 30′ in a polygon to give the transparent shaft 30′ a lens effect, the display part 12i of the case 12 can be displayed on an enlarged scale for further convenience. Alternatively, it is also possible to provide a through hole in part of the outer sleeve 22 instead of the transparent shaft 30′.

It is further possible to configure either the whole or part of the case 12 of transparent resin to make it a transparent shaft. This makes it possible to see leads in the lead tank 12a visible from outside and to know the state of accommodation of leads in the tank and the number of leads currently contained and accordingly the need, if any, to replace the lead cartridge 10.

FIG. 12 is a longitudinal sectional view of a lead cartridge according to another preferred embodiment of the present invention. The same or similar members as or to the foregoing embodiment will be assigned respectively the same reference signs, and their description will be dispensed with.

A lead cartridge 50 of this embodiment has a case 52, a packing 13, a guide sleeve 54, a spiral sleeve 56 and an eraser receptacle 16 to hold an eraser 18 which is a rod-shaped object.

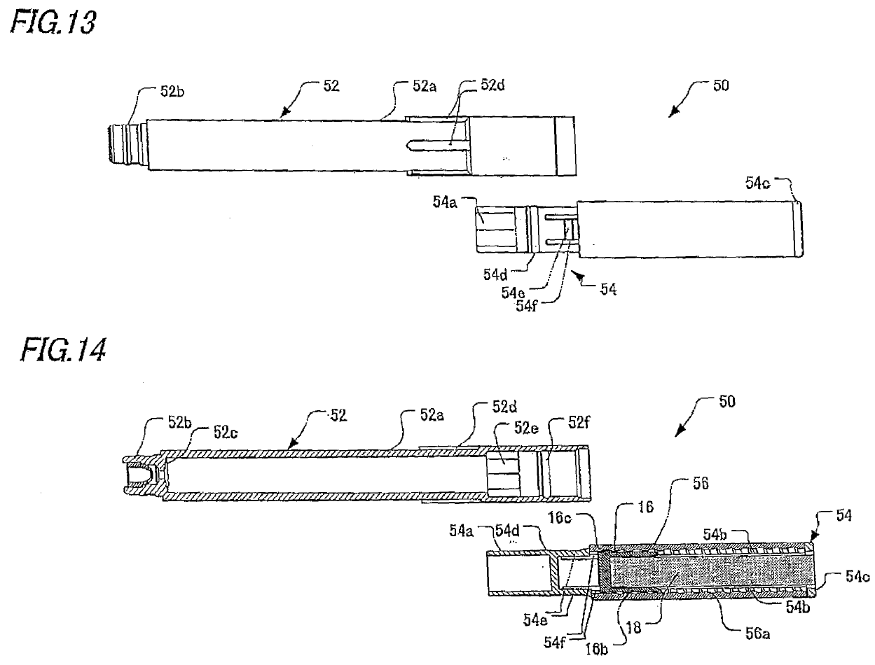

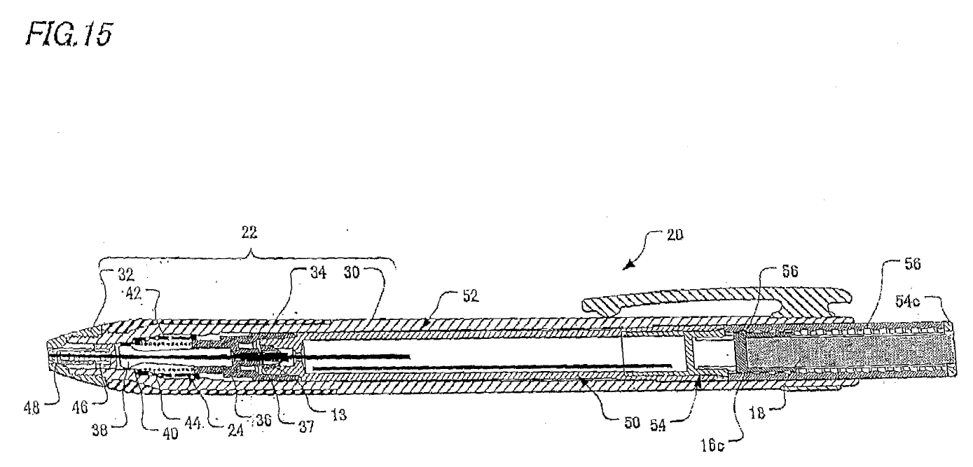

The case 52 is a hollow cylinder as shown in FIG. 13 and FIG. 14, comprising a lead tank 52a in its central portion to contain a plurality of leads for replenishment or replacement. The case 52 is provided on the front side of the lead tank 52a with a detachable coupling 52b having a reduced diameter than that of the portion defining the lead tank 52a. A contracted part 52c, reduced in bore, is formed on the boundary between the lead tank 52a and the detachable coupling 52b. The packing 13, composed of an elastic material, is so inserted into the detachable coupling 52b from its tip as to protrude toward the contracted part 52c

A plurality of ribs 52d for preventing rotation are provided on the outer circumferential surface of the case 52, to be meshed with the grooves 30a for preventing rotation of the body 30 of the outer sleeve 22 of the writing tool 20. The inner circumferential surface of the case 52 on the rear side of the lead tank 52a constitutes a polygonal hole portion 52e whose sectional profile is a polygon, and an annular concave rib 52f is formed as an engaging portion in the inner circumferential surface to rearward of the polygonal hole portion 52e.

A guide sleeve 54 engages with the polygonal hole portion 52e and the annular concave rib 52f of the case 52. Thus, the outer circumferential surface of the front of the guide sleeve 54 constitutes a polygonal part 54a whose sectional profile is shaped polygonal, and an annular convex rib 54d is formed as an engaging portion on the outer circumferential surface behind this polygonal part 54a. This polygonal part 54a is fitted into the polygonal hole portion 52e of the case 52, and the annular convex rib 54d engages with the annular concave rib 52f of the case 52. This engagement causes the guide sleeve 54 to be coupled to the case 52 so as to be unrotatable nor unmovable in the axial direction relative to the case 52. A pair of guide holes 54b extending in the axial direction are formed in the central portion of the guide sleeve 54, and an expanded-diameter part 54c is formed at the rear end of the guide sleeve 54.

Further, a pair of engaging pieces 54e axe formed on the outer circumferential surface of the guide sleeve 54. The engaging pieces 54e are surrounded by a U-shaped slit 54f formed in the circumferential surface of the guide sleeve 54, and are thereby enabled to be elastically displaced in the radial direction.

The spiral sleeve 56, held between the expanded-diameter part 54c and the engaging pieces 54e of the guide sleeve 54, is so arranged on the outer circumferential side of the guide sleeve 54 as to be unable to move in the axial direction but able to turn relative to the guide sleeve 54. A spiral groove 56a is formed in the inner circumferential surface of the spiral sleeve 56.

The eraser receptacle 16 is arranged within the guide sleeve 54 to be slidable in the axial direction relative to the guide sleeve 54 and to be turnable relative to the spiral sleeve 56. The pinching pieces 16b of the eraser receptacle 16 are fitted into the guide holes 54b of the guide sleeve 54 to be able to slide in the axial direction in the guide holes 54b, and at the same time the male thread 16c of the eraser receptacle 16 screws into the spiral groove 56a of the spiral sleeve 56,

The guide sleeve 54, the eraser receptacle 16 and the spiral sleeve 56 described above constitute a rod-shaped object feeding mechanism which is to be integrated with the lead cartridge 50.

FIG. 15 shows a state in which the lead cartridge 50 configured as described above is being incorporated into the mechanical pencil 20, which is a writing tool. This lead cartridge 50 can be fitted or removed in the same way as in the first preferred embodiment. When the lead cartridge 50 is incorporated into the mechanical pencil 20, the expanded-diameter part 54c of the guide sleeve 54 and part of the spiral sleeve 56 protrude from the rear end of the outer sleeve 22. When the rear end portion of this lead cartridge 50 is knocked, the chuck joint 36, the lead chuck 38 and the chuck ring 40 move ahead together with the lead cartridge 50, resulting in lead feeding as is well known to make the lead available for use in writing.

Further, when the eraser is to be used, the spiral sleeve 56 in the rear end portion is turned in a state in which the outer sleeve 22 is fixed. Since the outer sleeve 22 and the case 52 are prevented from relatively turning and the case 52 and the guide sleeve 54 are also prevented from turning, the eraser receptacle 16 which turns integrally with the guide sleeve 54 turns relative to the spiral sleeve 56. Then, as the male thread 16c of the eraser receptacle 16 moves along the spiral groove 56a, the eraser 18 is let out. When the spiral sleeve 56 is turned in the other direction, the eraser 18 is retreated into the spiral sleeve 56

Since the eraser 18 can be propelled in this way, a sufficient length in the axial direction can be secured for the eraser 18 until the lead cartridge 50 is up for replacement, making it unnecessary for the leads and the eraser to be replaced on separate occasions.

In this preferred embodiment, as the binding force between the case 52 and the chuck joint 36 is weaker than that between the case 52 and the guide sleeve 54, when the lead cartridge 50 is to be removed from the mechanical pencil 20, pulling the guide sleeve 54 of the lead cartridge 50 backward enables the whole lead cartridge 50 to be pulled out of the outer sleeve 22.

Also, when the remainder of the eraser 18 is still usable after the lead tank 52a runs out of leads and the cartridge 50 is pulled out of the mechanical pencil 20, it is possible to use the remaining eraser 18 by applying a strong force to disengage the engaging portions to release the case 52 and the guide sleeve 54 from each other and leaving only the rod-shaped object feeding mechanism.

FIG. 16 is a longitudinal sectional view of a lead cartridge according to still another preferred embodiment of the present invention. The same or similar members as or to the foregoing embodiment will be assigned respectively the same reference signs, and their description will be dispensed with

A lead cartridge 60 of this embodiment has a case 62, a packing 13, a guide sleeve 64, a spiral sleeve 66 and an eraser receptacle 16 to hold an eraser 18 which is a rod-shaped object.

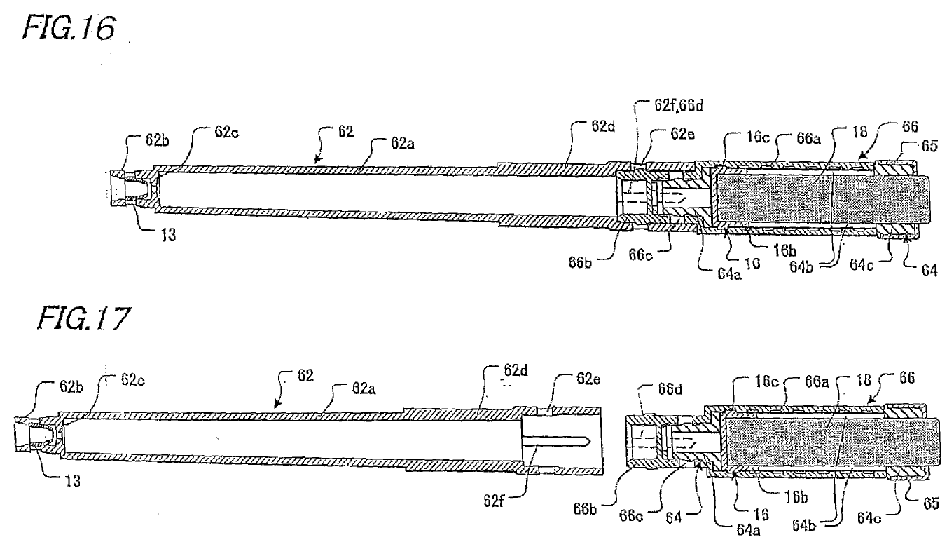

The case 62 is a hollow cylinder as shown in FIG. 17, comprising a lead tank 62a in its central portion to contain a plurality of leads for replenishment or replacement. The case 62 is provided on the front side of the lead tank 62a with a detachable coupling 62b having a reduced diameter than that of the portion defining the lead tank 62a. A contracted part 62c, reduced in bore, is formed on the boundary between the lead tank 62a and the detachable coupling 62b. The packing 13, composed of an elastic material, is so inserted into the detachable coupling 62b from its tip as to protrude toward the contracted part 62c.

A plurality of ribs 62d for preventing rotation are provided on the outer circumferential surface of the case 62, to be meshed with the grooves 30a for preventing rotation of the body 30 of the outer sleeve 22 of the writing tool 20. The outer circumferential surface of the case 62 on the rear side of the lead tank 62a is formed with engaging slots 62e as an engaging portion.

A spiral sleeve 66 engages with the engaging slots 62e of the case 62. Thus, the outer circumferential surface of the front of the spiral sleeve 66 is formed with engaging protrusions 66b as engaging portions, which engage with the engaging slots 62e of the case 62. This engagement causes the spiral sleeve 66 to be coupled to the case 62 so as to be unrotatable nor unmovable in the axial direction relative to the case 62, A spiral groove 66a is formed in the inner circumferential surface of the spiral sleeve 66 and engaging slots 66c are formed in the inner circumferential surface of the spiral sleeve 66 on the front side of the spiral groove 66a.

The guide sleeve 64 is inserted into the spiral sleeve 66 from the rear. An engaging tube 64a is formed at the front end of the guide sleeve 64, a pair of guide holes 64b extending in the axial direction are formed in the central portion of the guide sleeve 64, and a manipulating part 64c expanded in diameter is formed at the rear end of the guide sleeve 64. The manipulating part 64c may be provided with a decorating ring 65. The engaging tube 64a is adapted to be engaged with the engaging slots 66c of the spiral sleeve 66 when the guide sleeve 64 is inserted into the spiral sleeve 66.

The engagements between manipulating part 64c and the engaging elements 64a of the guide sleeve 64 and the spiral sleeve 66 allow the guide sleeve 64 to be arranged on the inner circumferential side of the spiral sleeve 66 so as to be unable to move in the axial direction but able to turn relative to the guide sleeve 66,

The eraser receptacle 16 is arranged within the guide sleeve 64 to be slidable in the axial direction relative to the guide sleeve 64 and to be turnable relative to the spiral sleeve 66. The pinching pieces 16b of the eraser receptacle 16 are fitted into the guide holes 64b of the guide sleeve 64 to be able to slide in the axial direction in the guide holes 64b, and at the same time the male thread 16c of the eraser receptacle 16 screws into the spiral groove 66a of the spiral sleeve 66.

The guide sleeve 64, the eraser receptacle 16 and the spiral sleeve 66 described above constitute a rod-shaped object feeding mechanism which is to be integrated with the lead cartridge 60.

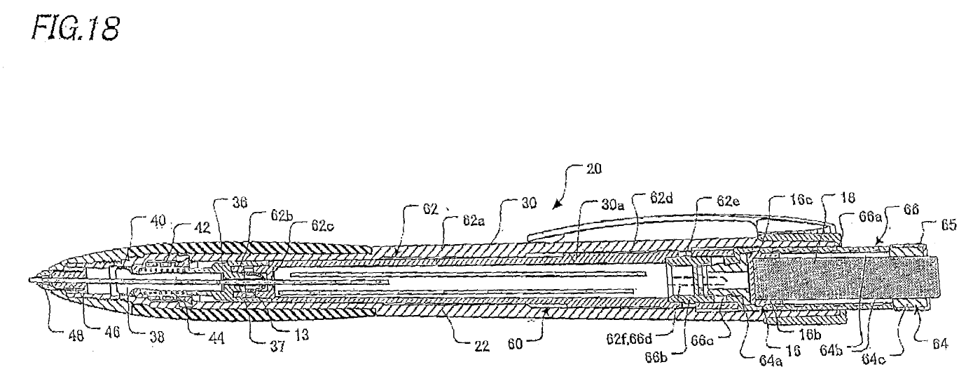

FIG. 18 shows a state in which the lead cartridge 60 configured as described above is being incorporated into the mechanical pencil 20, which is a writing tool. This lead cartridge 60 can be fitted or removed in the same way as in the first preferred embodiment. When the lead cartridge 60 is incorporated into the mechanical pencil 20, the manipulating part 64c of the guide sleeve 64 and part of the spiral sleeve 66 protrude from the rear end of the outer sleeve 22. When the rear end portion of this lead cartridge 60 is knocked, the chuck joint 36, the lead chuck 38 and the chuck ring 40 move ahead together with the lead cartridge 60, resulting in lead feeding as is well known to make the lead available for use in writing.

Further, when the eraser is to be used, the manipulating part 64c of the guide sleeve 64 in the rear end portion is turned in a state in which the outer sleeve 22 is fixed. Since the outer sleeve 22 and the case 62 are prevented from relatively turning and the case 62 and the spiral sleeve 66 are also prevented from relatively turning, the eraser receptacle 16 which turns integrally with the guide sleeve 64 turns relative to the spiral sleeve 66. Then, as the male thread 16c of the eraser receptacle 16 moves along the spiral groove 66a, the eraser 18 is let out. When the manipulating part 64c is turned in the other direction, the eraser 18 is retreated into the spiral sleeve 66.

Since the eraser 18 can be propelled in this way, a sufficient length in the axial direction can be secured for the eraser 18 until the lead cartridge 60 is up for replacement, making it unnecessary for the leads and the eraser to be replaced on separate occasions.

In this preferred embodiment, as the binding force between the case 62 and the chuck joint 36 is weaker than that between the case 62 and the spiral sleeve 66, when the lead cartridge 60 is to be removed from the mechanical pencil 20, pulling the spiral sleeve 66 of the lead cartridge 60 backward enables the whole lead cartridge 60 to be pulled out of the outer sleeve 22

Also, when the remainder of the eraser 18 is still usable after the lead tank 62a runs out of leads and the cartridge 60 is pulled out of the mechanical pencil 20, it is possible to use the remaining eraser 18 by applying a strong force to disengage the engaging portions to release the case 62 and the guide sleeve 66 from each other and leaving only the rod-shaped object feeding mechanism.

While the principles of the invention have been described above in connection with specific embodiments, and particular modifications thereof, it is to be clearly understood that this description is made only by way of example and not as a limitation on the scope of invention.

What is claimed is:

1. A lead cartridge including a tank for containing leads and adapted to be detachably incorporated into a writing tool to supply leads, comprising:
a rod-shaped object feeding mechanism for propelling a rod-shaped object by a turning manipulation.

2. The lead cartridge according to claim 1, wherein said rod-shaped object feeding mechanism comprises a spiral groove formed in the inner circumferential surface of a case comprising said tank, a guide sleeve which is disposed within the case so as to be unmovable in the axial direction and rotatable relative to the case and is formed with a guide hole extending in the axial direction, and a receptacle for holding the rod-shaped object, said receptacle being slidably fitted into the guide hole of the guide sleeve and having a male thread screwing into said spiral groove, wherein when the lead cartridge is incorporated into the writing tool, the case becomes unable to turn relative to an outer sleeve of the writing tool, and part of the guide sleeve protrudes from the writing tool to be subjected to turning manipulation.

3. The lead cartridge according to claim 1, wherein said rod-shaped object feeding mechanism comprising a guide sleeve which is coupled to a case comprising said tank so as to be unmovable in the axial direction and unrotatable relative to the case and is formed with a guide hole extending in the axial direction, a spiral sleeve which is arranged on the outer circumferential side of the guide sleeve so as to be unmovable in the axial direction and rotatable relative to the guide sleeve and is formed in an inner circumferential surface with a spiral groove, and a receptacle for holding a rod-shaped object, said receptacle being slidably fitted into the guide hole of the guide sleeve and having a male thread screwing into said spiral groove, wherein when the lead cartridge is incorporated into the writing tool, the case becomes unable to turn relative to an outer sleeve of the writing tool and part of the spiral sleeve protrudes out of the writing tool to be subjected to turning manipulation.

4. The lead cartridge according to claim 1, wherein said rod-shaped object feeding mechanism comprising a spiral sleeve which is coupled to a case comprising said tank so as to be unmovable in the axial direction and unrotatable relative to the case and is formed in an inner circumferential surface with a spiral groove, a guide sleeve which is arranged on the inner circumferential side of the spiral sleeve so as to be unmovable in the axial direction and rotatable relative to the spiral sleeve and is formed with a guide hole extending in the axial direction, and a receptacle for holding a rod-shaped object, said receptacle being slidably fitted into the guide hole of the guide sleeve and having a male thread screwing into said spiral groove, wherein when the lead cartridge is incorporated into the writing tool, the case becomes unable to turn relative to an outer sleeve of the writing tool and part of the guide sleeve protrudes out of the writing tool to be subjected to turning manipulation.

5. The lead cartridge according to claim 2, wherein said guide sleeve engages with an engaging portion formed on the circumferential surface of the case comprising said tank to be held so as to be unmovable in the axial direction within the case.

6. The lead cartridge according to claim 3, wherein said guide sleeve engages with an engaging portion formed on the circumferential surface of the case comprising said tank to be held so as to be unmovable in the axial direction within the case.

7. The lead cartridge according to claim 4, wherein said spiral sleeve engages with an engaging portion formed on the circumferential surface of the case comprising said tank to be held so as to be unmovable in the axial direction within the case.

8. The lead cartridge according to claim 1, wherein a display part on which lead information regarding leads contained in said tank is displayed is provided on the outer circumferential part of the lead cartridge.

9. The lead cartridge according to claim 1, wherein at least part of the case comprising said tank is composed of a transparent material which makes visible the inside of the tank.

10. A writing tool into which the lead cartridge according to claim 8 is to be incorporated, comprising an outer sleeve and wherein the lead cartridge is made visible through at least part of the outer sleeve of the writing tool.

11. A writing tool into which the lead cartridge according to claim 9 is to be incorporated, comprising an outer sleeve and wherein the lead cartridge is made visible through at least part of the outer sleeve of the writing tool.

12. The writing tool according to claim 10, wherein said at least part of the outer sleeve of the writing tool is composed of a transparent material and the part composed of the transparent material comprising a lens.

13. The writing tool according to claim 11, wherein said at least part of the outer sleeve of the writing tool is composed of a transparent material and the part composed of the transparent material comprising a lens.
